(19) United States
(12) Patent Application Publication
(10) Pub. No.: US 2012/0064970 A1
(43) Pub. Date: Mar. 15, 2012

(54) Electronic Gaming System and Method

(75) Inventor: Tobias Drewry, Sharon, MA (US)

(73) Assignee: Mesa Mundi, Inc., Sharon, MA (US)

(21) Appl. No.: 12/879,303

(22) Filed: Sep. 10, 2010

(51) Int. Cl. A63F 13/00

(52) U.S. Cl. 463/30

(57) ABSTRACT

Systems and methods for projecting game boards are provided. In one embodiment an image source transmits a gaming surface image; a display surface having an upper surface face and a lower surface face, is configured to receive the gaming surface image against the lower surface face and display the gaming surface image through the upper surface face. An interaction interface arranged over the display surface is configured to register interaction input actions; and an interaction detector is configured and arranged to detect the interaction input actions registered by the interaction surface and communicate the interaction input actions to a computer. A computer configured to send gaming surface information to the image source and receive the interaction input actions from the interaction detector is also included. The system also includes a frame supporting the display surface and the interaction surface including a recess containing the display surface and the interaction surface.

### 1 BACKGROUND OF THE INVENTION

1.1 Field of the Invention

The present invention provides systems, apparatus, and methods for playing games that use two- and three-dimensional graphical surfaces, such as cartographic and architectural maps, commonly known as “board games”. The invention has applications in the areas of entertainment, gaming, and electronics.

1.2 The Related Art

Mankind has been playing board games (i.e., games that use a playing surface and are (usually) dimensioned to be played on a table top or area of similar dimensions) for millennia: the origins of the game known today as “chess” can be traced through India, Asia, and Japan to a time nearly 1,000 years ago; “backgammon” was known as long ago as 2,500 B.C.; and the game “go” has been estimated to have been first played in 2,300 B.C. Hieroglyphs dating from 3,100 B.C. (pre-dynastic Egypt) have been interpreted to depict a game called “senet”, copies of which have been found in Egyptian tombs having origins as old as 3,500 B.C., which includes a game board comprising a grid of thirty squares arranged in three rows of ten, over which two sets of at least five pawns are moved. The original rules of the game are still a topic of debate, but some historians have proposed sets of rules that have been used for versions of senet sold currently.

Generally, board games seek to enable players to transcend intellectually the constraints of earthly existence for a period of time, usually that time needed to conclude the game, by providing rules and story lines that are fanciful or capture times, places, or activities (or some combination thereof) that are not accessible physically to the players. Often games create imaginary situations that depict activities that are not physically possible or, if possible, not sanctioned by society absent extreme duress. Common game subjects include science fiction and fantasy subjects and historical events, the latter usually focused on armed conflict (“war games”). Probably the best known and most widely played fantasy-based game is Dungeons & Dragons, first developed by E. Gary Gygax and David Arneson in the 1970s and which has spawned a very active hobby and supporting niche industry. Popular war game titles include Risk, Stratego, Axis & Allies, and Advanced Squad Leader. Although the popularity of board games dropped as a consequence of the spread of video games, this type of gaming has enjoyed a resurgence of late as gamers seek more physical interaction with other players and the topical and aesthetic limits of video gaming have become apparent.

Typically a board game includes a “game board” or playing surface that provides the game's boundaries and often includes graphics that help the players envision the alternate reality represented by the game as well as provide obstacles and objectives that are part of the game. Many such games include physical playing pieces (often cardboard, plastic, or metal representations of the characters or combatants in the game) that move over the game board in accordance with the rules. In addition, many games require some type of accounting (or “bookkeeping”) as the game pieces are moved over the board to account for various events, interactions, and the accumulation or depletion of resources as required by the rules. In such cases the players, or a non-playing participant, must coordinate the movement and location of the playing pieces with the events and other activities associated with game play. Inevitably errors occur in which events or accountings are not executed in accordance with the rules, leading to reduced enjoyment of the game, disagreements, full-blown arguments, and worse.

While it is possible to use computers to address these problems, simply entering cöordinate data into a rules-based accounting program is time consuming and tedious. Some systems have been developed that provide a board image, employ various means for tracking the movement of game pieces, and use the tracking information to adjust the view of the board image and perform necessary accounting required by the game's rules. However, these systems are expensive and offer limited game board dimensions and visual quality. Thus there remains a need for systems that facilitate game play at a lower cost. The present invention meets these and other needs.

### 2 SUMMARY OF EMBODIMENTS OF THE INVENTION

In one embodiment, the present invention provides an electronic gaming system including a scalable projected playing field. In some embodiments, the gaming system provided by the invention comprises: an image source configured to transmit under computer control a gaming surface image; a display surface having an upper surface face and a lower surface face, the display surface configured to receive the gaming surface image against the lower surface face and display the gaming surface image through the upper surface face; an interaction interface arranged over the display surface, the interaction surface being configured to register interaction input actions; an interaction detector configured and arranged to detect the interaction input actions registered by the interaction surface and communicate the interaction input actions to a computer; a computer configured to send gaming surface information to the image source and receive the interaction input actions from the interaction detector; and a frame, the frame supporting the display surface and the interaction surface, the frame further including a recess containing the display surface and the interaction surface.

Other embodiment further include those in which the image source is a projector; still more specific embodiments include those in which the projector is mounted under the display surface; and yet more specific embodiments include those further comprising a mirror configured to reflect image information transmitted from the image source to the lower surface face of the display surface.

In some embodiments, the above-mentioned recess is between about six inches and about one inch deep. Among these embodiments, more specific embodiments include those in which the projector is mounted under the display surface; still more specific embodiments include those further comprising a mirror configured to reflect image information transmitted from the image source to the lower surface face of the display surface.

In other embodiments, the recess is between about five inches and about two inches deep. Among these embodiments, more specific embodiments include those in which the projector is mounted under the display surface; still more specific embodiments include those further comprising a mirror configured to reflect image information transmitted from the image source to the lower surface face of the display surface.

In still other embodiments, the recess is about three inches deep. Among these embodiments, more specific embodiments include those in which the projector is mounted under the display surface; still more specific embodiments include those further comprising a mirror configured to reflect image information transmitted from the image source to the lower surface face of the display surface.

In a second aspect, the present invention provides a method for playing a game. In some embodiments, the method provided by the invention comprises: providing an electronic gaming table having a recess containing a display surface and an interaction surface; projecting a gaming surface image against the lower surface face of a display surface having an upper surface face and a lower surface face; registering an interaction input action on an interaction interface arranged over the display surface; receiving an interaction input action signal at an interaction detector; sending the interaction input action signal to a computer configured to receive the interaction input signal; and modifying the gaming surface image in accordance with the interaction input signal.

In more specific embodiments, the recess is between about six inches and about one inch deep; in still more specific embodiments the recess is between about five inches and about two inches deep; and in yet more specific embodiments, the recess is about three inches deep. Among the latter embodiments, still more specific embodiments include those in which the projector is mounted under the display surface; yet more specific embodiments include those further comprising a mirror configured to reflect image information transmitted from the image source to the lower surface face of the display surface.

The present invention provides a more satisfying gaming experience, as will be better understood and appreciated by those having ordinary skill in the art upon reading the Detailed Description below with the accompanying Drawings.

### 3 BRIEF DESCRIPTION OF THE DRAWINGS

Exemplary embodiments of the present invention are described herein with reference to the following drawings, in which:

FIG. 1 is a perspective view of an embodiment of a gaming system in accordance with the present invention.

FIG. 2A is a top view of the embodiment of a gaming system in accordance with the present invention shown in FIG. 1. FIG. 2B is a side view of a gaming system in accordance with the present invention shown in FIG. 1.

FIG. 3 is a exploded view of the components of an interaction interface and a display surface in accordance with the present invention.

FIG. 4 is a schematic view of the arrangement of an image source, mirror, and the lower surface face of the display surface in accordance with the present invention.

FIG. 5 is a schematic view of the relative dispositions of the image source and mirror in accordance with one embodiment of the present invention.

FIG. 6 is an illustration of the basic elements of a general computer system in accordance with the present invention.

### 4 DETAILED DESCRIPTION OF SOME EMBODIMENTS OF THE INVENTION

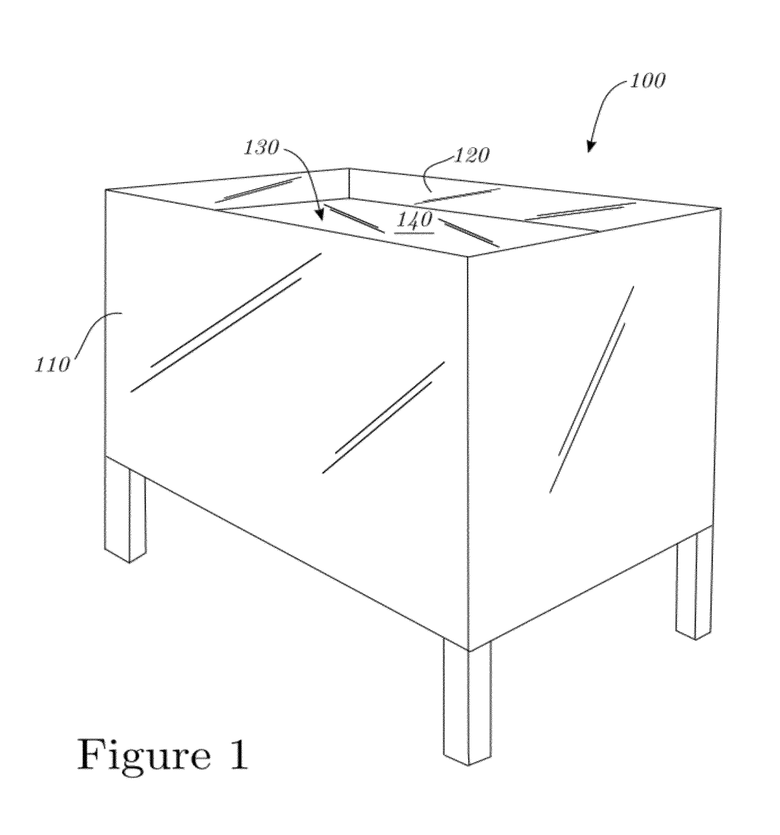

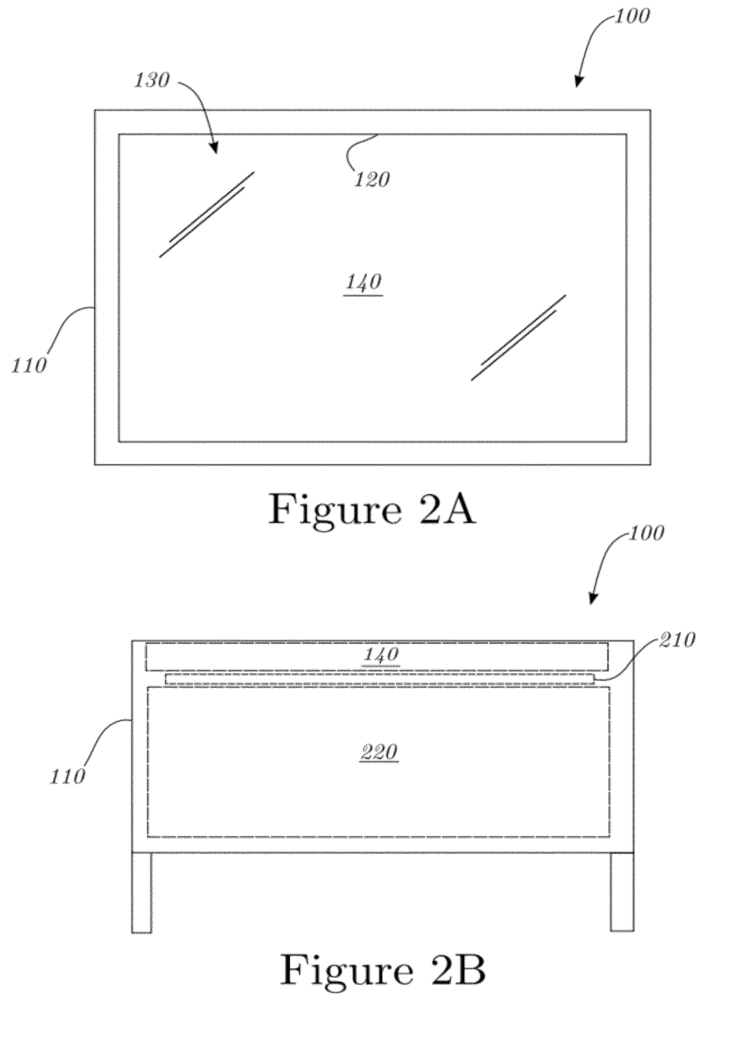

FIG. 1 illustrates a gaming system in accordance with the present invention (100), including a housing (110), made of any suitable material for supporting and housing the components of the gaming system of the invention and withstanding the interactions of the players therewith. Examples of suitable materials include wood, plastics, and metals. The choice of materials and their combination to make the housing will be familiar to those having ordinary skill in the art. The housing includes an interior wall that is accessible to the players (120) made from the same materials as the rest of the housing (110). Enclosed by the interior wall is a display surface (130) that is configured to provide a surface upon which player interactions are registered as described further below. Together, the interior wall (120) and interaction surface (130) define a recess (140) which has been found surprisingly to provide better visibility of the display as described below. In some embodiments, the recess is between about one inch and about six inches deep. In other embodiments, the recess is between about five inches and about two inches deep. In still other embodiments, the recess is about three inches deep. FIG. 2A provides an illustration of the top view of the gaming system (100). FIG. 2B provides a side view of the gaming system (100), further showing the arrangement of the interaction interface and display surface (210) (dashed lines) within the housing, and an interior compartment (220) (dashed lines) into which other components are arranged as described hereinbelow.

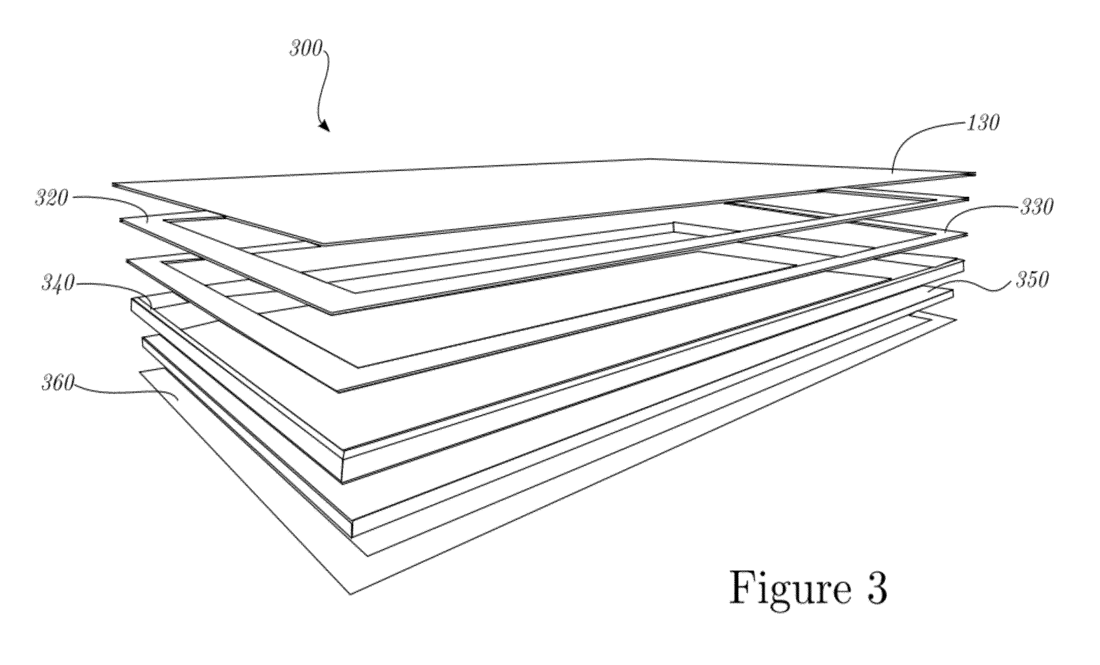

FIG. 3 illustrates an exploded view of the interaction interface and display surface, and related elements, in accordance with one embodiment of the invention (300). In the illustrated embodiment, display surface (130) is arranged at the top of a layered structure, above a matte or baffle (320), upper border (330), infrared illumination frame (340), interaction interface (350), and lower border (360)), each of which is described below. The display surface (130) can be made from any device or material effective to transmit a two-dimensional image consistent with the details described herein. In one embodiment, the display surface is a sheet of rear projection acrylic, such as sold commercially by Evonik Industries (http://www.acryliteshop.com/US/us/index.htm) under the designation Rear Projection, sheet, Grey 7D006 RP. Other suitable materials an suppliers will be familiar to those having ordinary skill in the art. In such embodiments, an image is projected from beneath the display surface, i.e., on the lower face of the display, using an image projector as, embodiments of which are described below.

Immediately below the display surface (130) is a matte or baffle (320) framing the border around the display surface (i.e., the opening in the matte or baffle (320) is dimensioned to be substantially about the same dimension as the image shown on the display surface (130). The matte or baffle (320) functions to block substantially any detection of movement outside of the area of the displayed image, which, when the image comprises as gaming are or projected “game board”, substantially prevents the detection of movements outside the bounds of play. In some embodiments, the matte or baffle is between about one-half inch and about two inches wide. In other embodiments, the matte or baffle (320) is arranged over the display surface (130).

Behind display surface (130) is the interaction interface (350), which registers interactions with the display surface (130), such as finger or pointer movements, or the movement of playing pieces. In one embodiment, the interaction interface applies an infra-red illumination technique called Diffused Surface Illumination or “DSI”, which is familiar to those having ordinary skill in the art. One suitable material for the interaction interface (350) is sold under the trade name ENDLIGHTEN by Evonik Industries. In combination with an infrared detector, such as a camera with an IR filter (not shown), such a technique allows for finger tracking or tracking the signal created by an infra-red pointing device (the fabrication of which is described publicly at http://arch.eece.maine.edu/ideas/images/7/7f/Wiimote.pdf) in addition to object and fiducial tracking. In another embodiment, the interaction interface uses Frustrated Total Internal Reflection (“FTIR”). As will be familiar to those having ordinary skill in the art, FTIR requires several layers of complex materials that mesh to achieve a touch surface. This technique is reliable for multi-touch; however, some users find that it does not allow for the smoothest sensation and requires pressure on the part of the user for touch tracking to be maintained. In still another embodiment, the interaction interface uses Diffused Illumination (“DI”), also familiar to those having ordinary skill in the art, and which is perhaps the simplest technique of the three and utilizes one or more banks of IR emitters which flood the area with infrared light. Regardless of the choice for the mechanism of the interaction display, in some embodiments, a diffuser is used as both the rear-projection surface and a means to distribute the IR light evenly across the touch surface. Below this an acrylic panel is used for the touch surface itself. In alternative embodiments, described below, this arrangement can be reversed.

In some embodiments, an upper border (330) and a lower border (360) are provided around the edges of the upper and lower surfaces of the interaction interface (350) to prevent unwanted reflections and outside radiation interference and help intensify the infra-red light in the center of the interaction interface. In some embodiments, the infra-red radiation is provided by an infrared illumination frame (340) which encases the edge of the interaction interface and further includes infrared illumination sources (e.g., infrared light-emitting diodes) arranged to provide a substantially uniform infrared illumination of the interior of the interaction interface. In one embodiment, the frame has a substantially C-shaped cross section defining a channel into which the edge of the interaction interface can be inserted. Within the channel, substantially in the plane of the interaction interface, are arranged infra-red LEDs. In another embodiment (not shown), the infrared illumination frame (350) is provided in four sections or segments, each section having a length substantially the same as an edge of the interaction interface, so that the frame does not define full corners as depicted in the Figure. Such an arrangement has been found to have surprisingly good performance characteristics. In some embodiments, regardless of the choice of frame, the channel depth is between about one inch and about two inches; more specifically between about one inch and about 1.5 inches, and still more specifically about 1.2 inches. Additionally, the frame provides a rim that provides in turn the user with the sensation of an obstacle which naturally encourages the user to reach into the touch surface rather than slide his/her hand along a parallel path. This leads to more accurate touch events and a more seamless experience for the user. In some embodiments, the above-described upper and lower borders are omitted.

In other embodiments, the location of the display surface and the interaction interface (including the associated illumination frame and borders described therewith) is swapped from the relative positions shown in FIG. 3. In other words, in these embodiments, the interaction interface is located on the top (i.e., in the location shown at 130) and the display surface is located below the interaction interface.

The invention also includes a detector (not shown) to detect interactions between players or users and the interaction interface. In some embodiments, the detector is a camera configured to detect infrared radiation coming from a direction substantially perpendicular to the interaction interface due to the movement of a finger, pointer, or object such as a playing piece (the latter may include additional reflective material on the bottom to enhance sensitivity). Without wishing to be bound by an particular theory of operation, motions above the interaction interface (regardless of position of the interface relative to the display surface) cause changes in the location and intensity of reflected infrared light that is emitted from the interaction interface in directions out of the plane of the interaction interface. Such changes are detected by the camera and converted to signals that are sent to a computer for processing as described below. In other embodiments, two or more cameras or detectors are used to provide “multi-touch” capability. The selection and operation of such detectors (including cameras) is known to those having ordinary skill in the art. One suitable camera is sold commercially by Point Grey (http://www.ptgrey.com/).

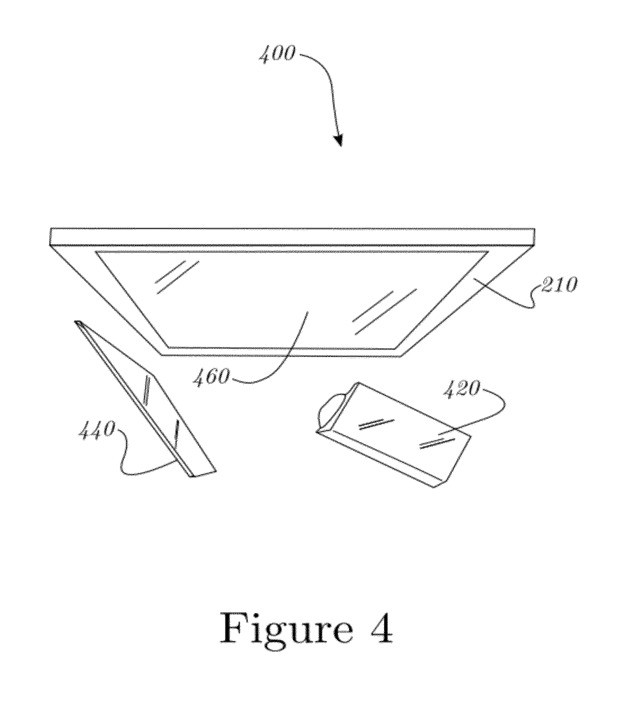

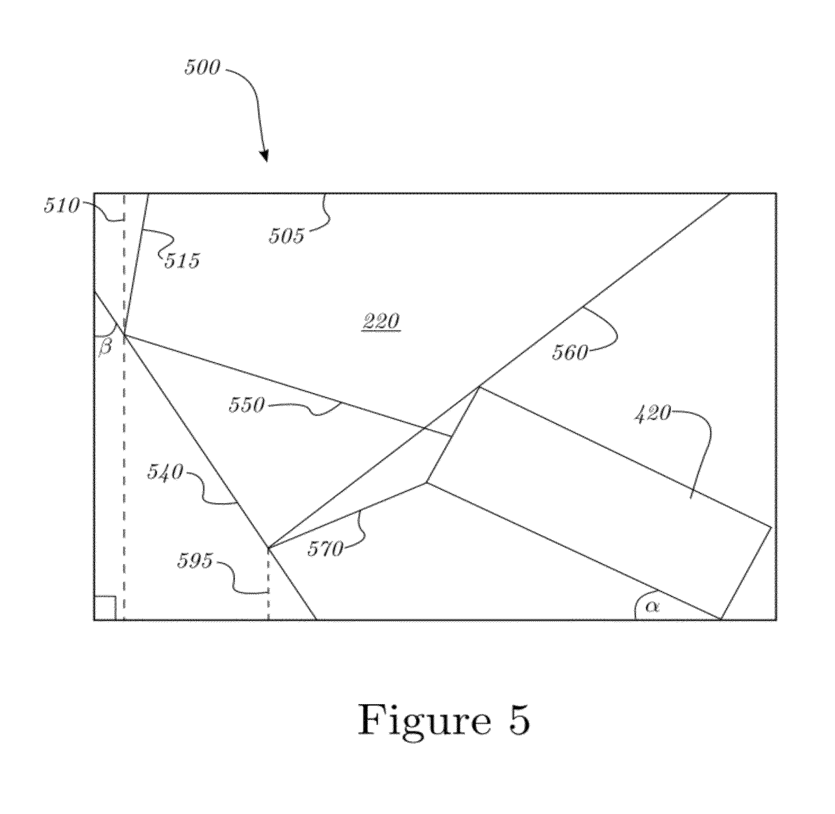

Regardless of the relative positions of the display surface and interaction interface (and associated elements), a projector is provided to project a gaming surface image on to the lower surface face (460) of the display surface. One embodiment including such a projector is shown in FIG. 4 at 400; there, a projector (420) and mirror (440) are arranged in interior compartment (220). Images sent from a computer (not shown) to the projector are projected by the projector onto the mirror and reflected upward by the mirror onto the lower surface face of the display surface to provide a projected gaming surface image. One particular arrangement of the projector (420), mirror and lower surface face is provided at 500 in FIG. 5. There, the region of the display surface that receives the projected image (505) is defined by the edges of the reflected light cone defined by reflected light rays 515 and 560, which are the reflections of the edges of the projected light cone 550 and 570 respectively. The mirror 440 (not shown) lies along line 540, which is at angle β relative to the vertical wall of the housing (which is substantially square relative to the floor of the housing). The projector is placed at an angle α, such that the projected image is substantially square. Using these definitions, the length of the mirror is defined by the length of the segment of line 540 between dashed lines 515 and 595. Following this arrangement provides a substantially clear image that is substantially free of “keystoning”. Moreover, the arrangement shown in FIG. 5 enables scaling of the projected image, so that projected gaming surfaces of various dimensions can be provided with relative ease compared to commercially available products.

Signals from the camera or cameras are relayed and processed by a computer as mentioned above. The computer processes the signals and adjusts the projected image accordingly if required by the game rules. The computer may provide additional information about the status of various game elements or players either to a referee or directly on the projected gaming surface image. Suitable software for providing such processing is known in the art, for example, the software available under the GNU Public License known as “CCV” (Community Core Vision versions 1.2 and 1.3), as well as software known as MULTITOUCH VISTA, MS HID, and REACTIVISION. Additional software is available from public or commercial sources, such as MT4j, PyMT, Touchlib, and MICROSOFT SURFACE TOUCHPACK.

In some embodiments, a publicly available, Java-based application RPTools MapTool is used to enable gaming on a multi-touch surface. MapTool can be used to present any token and map based game quickly and accurately. The MapTool application offers a diverse selection of utilities for gamers to envision game spaces, and it also provides a scripting language for handling random events such as dice rolling. Combining this software with a multi-touch enabled surface results in an interactive gaming experience using digital tokens. Using RPTools MapTool, a gaming group is also able to share games played on the multi-touch surface with remote players. For example, in a group game, one or more remote players can log into the MapTool server and move their tokens around the board. Such a capability allows for the physical players to have a social gaming experience while still allowing for the remote player or players to join in the game. Combined with a video chat or audio chat software (such as SKYPE), a remote player can interact with multiple players simultaneously, both verbally and “physically”.

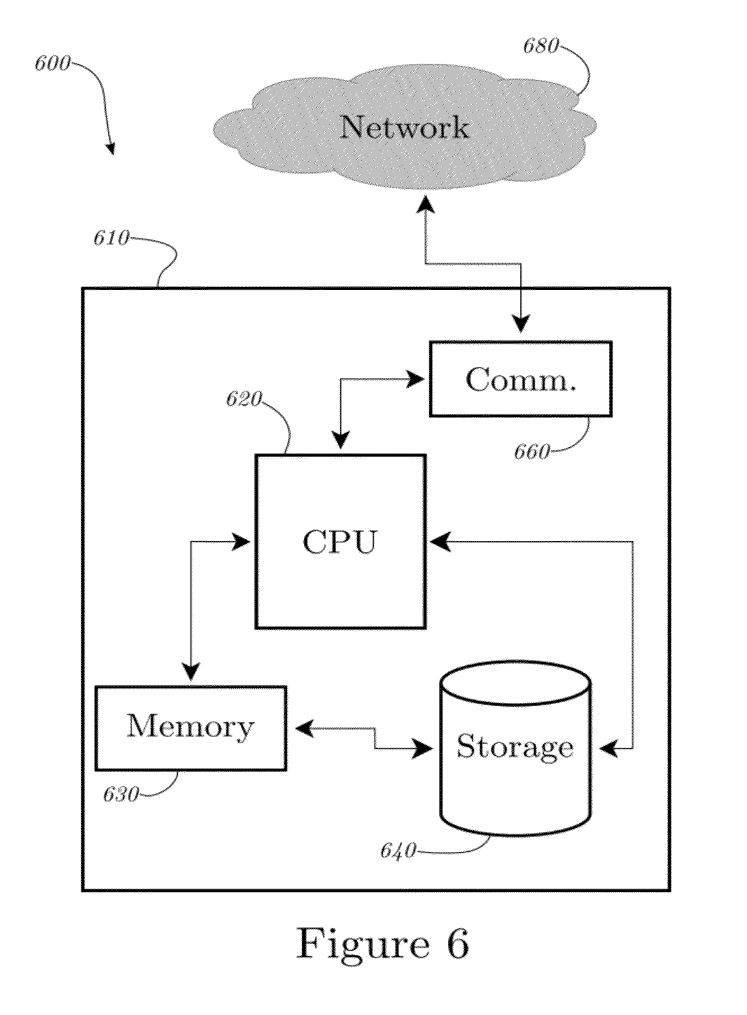

The methods described herein can be encoded on a computer-readable medium and executed as computer-readable program code devices that are configured to enable a general purpose electronic computing machine (FIG. 6 at 600). Such a machine (610) includes a central processor unit “C.P.U.” (620), volatile memory (630), non-volatile storage (640), and a communications interface (660). The computer may communicate with a network (680) as well as the above-described camera(s) and projector. In operation, the computer executes software to provide a projection of a gaming surface through the display surface as well as initialize other software functions to keep track of player actions and status, and the display of any data. As the players either gesture or move playing pieces over the projected gaming surface, the changes in reflected infra-red light from the interaction interface are registered by the camera(s) and the corresponding signals are relayed to the computer. The signals are processed, and the computer program causes an appropriate response, including, but not limited to, updating the gaming surface, updating player status, updating displayed information, or any combination thereof (including no action).

### 5 CONCLUSION

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

It will be apparent to those of ordinary skill in the art that the present invention provides an electronic gaming system including a scalable projected playing field. Using the system and methods described herein, game players can enjoy a better interactive gaming experience.

What is claimed:

1. An electronic gaming system including a scalable projected playing field, comprising:
an image source configured to transmit under computer control a gaming surface image;
a display surface having an upper surface face and a lower surface face, said display surface configured to receive said gaming surface image against said lower surface face and display said gaming surface image through said upper surface face;
an interaction interface arranged over said display surface, said interaction surface being configured to register interaction input actions;
an interaction detector configured and arranged to detect said interaction input actions registered by said interaction surface and communicate said interaction input actions to a computer;
a computer configured to send gaming surface information to said image source and receive said interaction input actions from said interaction detector; and
a frame, said frame supporting said display surface and said interaction surface, said frame further including a recess containing said display surface and said interaction surface.

2. The electronic gaming system of claim 1, wherein said image source is a projector.

3. The electronic gaming system of claim 2, wherein said projector is mounted under said display surface.

4. The electronic gaming system of claim 3, further comprising a mirror configured to reflect image information transmitted from said image source to said lower surface face of said display surface.

5. The electronic gaming system of claim 1, wherein said recess is between about six inches and about one inch deep.

6. The electronic gaming system of claim 5, wherein said projector is mounted under said display surface.

7. The electronic gaming system of claim 6, further comprising a mirror configured to reflect image information transmitted from said image source to said lower surface face of said display surface.

8. The electronic gaming system of claim 5, wherein said recess is between about five inches and about two inches deep.

9. The electronic gaming system of claim 8, wherein said projector is mounted under said display surface.

10. The electronic gaming system of claim 9, further comprising a mirror configured to reflect image information transmitted from said image source to said lower surface face of said display surface.

11. The electronic gaming system of claim 8, wherein said recess is about three inches deep.

12. The electronic gaming system of claim 11, wherein said projector is mounted under said display surface.

13. The electronic gaming system of claim 12, further comprising a mirror configured to reflect image information transmitted from said image source to said lower surface face of said display surface.

14. The electronic gaming system of claim 13, wherein said image source is a projector.

15. A method for playing a game, comprising:
providing an electronic gaming table having a recess containing a display surface and an interaction surface;
projecting a gaming surface image against the lower surface face of a display surface having an upper surface face and a lower surface face;
registering an interaction input action on an interaction interface arranged over said display surface;
receiving an interaction input action signal at an interaction detector;
sending said interaction input action signal to a computer configured to receive said interaction input signal; and
modifying said gaming surface image in accordance with said interaction input signal.

16. The method of claim 15, wherein said recess is between about six inches and about one inch deep.

17. The method of claim 16, wherein said recess is between about five inches and about two inches deep.

18. The method of claim 17, wherein said recess is about three inches deep.

19. The method of claim 18, wherein said projector is mounted under said display surface.

20. The method of claim 19, further comprising a mirror configured to reflect image information transmitted from said image source to said lower surface face of said display surface.
